(19) United States
(12) Patent Application Publication
(10) Pub. No.: US 2025/0087217 A1
(43) Pub. Date: Mar. 13, 2025

(54) LOW-LATENCY SPEAKER SEPARATION

(71) Applicants: GM Global Technology Operations LLC, Detroit, MI (US); Bar-Ilan University, Ramat Gan (IL)

(72) Inventors: Boris Rubenchik, Tel Aviv-Yafo (IL); Elior Hadad, Ness-Ziona (IL); Eli Tzirkel-Hancock, Raanana (IL); Sharon Gannot, Tel-Aviv (IL); Ethan Fetaya, Kiryat Ono (IL)

(73) Assignees: GM Global Technology Operations LLC, Detroit, MI (US); Bar-Ilan University, Ramat Gan (IL)

(21) Appl. No.: 18/466,503

(22) Filed: Sep. 13, 2023

(51) Int. Cl. G10L 17/06; G10L 21/028

(52) U.S. Cl. CPC G10L 17/06; G10L 21/028

(57) ABSTRACT

A system for speech separation includes data processing hardware and memory hardware in communication with the data processing hardware, the memory hardware storing instructions that when executed on the data processing hardware cause the data processing hardware to perform operations including (i) generating a two-dimensional representation of a speech mixture, (ii) separating the speech mixture into an initial separation (iii) supplying the initial separation and speaker representations to a refinement module, (iv) refining the initial separation based on the initial separation and the speaker representations, (v) estimating a mask per speaker, and (vi) applying the masks to the two-dimensional representation to create two-dimensional, per-speaker representations.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a system and method for speech separation and, more particularly, to a system and method for low-latency, single-microphone speech separation utilizing speaker representations.

Speech separation is directed toward separating target speech from background interference and may be used in a wide range of applications. For example, speech separation may be used by a processor associated with a hearing prosthesis or by a communication device such as a mobile phone or tablet. In each of the foregoing applications, speech separation is employed to separate desired speech from background interference such as other speakers, noise, and/or music.

In the context of a hearing prosthesis, such as a hearing aid, a processor associated with the hearing aid separates desired signals associated with speakers, music, and/or a communication device such as a mobile phone or tablet from background noise such as signals associated with construction, road noise, wind, and the like. In the context of a communication device such as a mobile phone, a processor associated with the mobile phone separates desired signals associated with a speaker from undesirable signals associated with interference such as signals associated with background music, construction, road noise, and the like.

When a phone call is placed in a vehicle on a mobile device or by a system associated with the vehicle, a processor associated with the mobile device or the vehicle attempts to separate desired signals associated with the speech of the person or persons talking within a cabin of the vehicle from undesired signals associated with background noise in and around the vehicle. As can be appreciated, in the context of a vehicle, background noise is often abundant and stems from a variety of causes. Namely, background noise may stem from road noise, construction, operation of vehicle systems such as radios, windows, and door locks to name a few; operation of other vehicles, as well as other vehicle occupants.

With respect to background noise stemming from other vehicle occupants, speech separation may be utilized to separate the speech of the various occupants located within the cabin to attribute the speech to the appropriate occupant. In this context, speech separation may be used to solve the so-called cocktail party problem, where multiple people are speaking at the same time in a single location. In the present example, the multiple vehicle occupants are all located within the vehicle cabin and may speak at the same time, thereby necessitating the need to separate and attribute the speech to each occupant.

In short, while speech separation presents a difficult task for any device, speech separation within a vehicle is often exacerbated due to the ever-changing environment within the vehicle, the numerous conditions in and around the vehicle that contribute to interference, and the general unpredictability of the interference experienced during operation of the vehicle.

### SUMMARY

A system for speech separation is provided and includes data processing hardware and memory hardware in communication with the data processing hardware, the memory hardware storing instructions that when executed on the data processing hardware cause the data processing hardware to perform operations including (i) generating a two-dimensional representation of a speech mixture, (ii) separating the speech mixture into an initial separation (iii) supplying the initial separation and speaker representations to a refinement module, (iv) refining the initial separation based on the initial separation and the speaker representations, (v) estimating a mask per speaker, and (vi) applying the masks to the two-dimensional representation to create two-dimensional, per-speaker representations.

The system may include one or more of the following optional features. For example, generating a two-dimensional representation of the speech mixture may include passing the speech mixture through an encoder. Additionally or alternatively, at least one feature projection may be supplied to the refinement module for use by the refinement module in refining the initial separation.

A speaker embedding table may be used to refine the speaker representations. Additionally or alternatively, the two-dimensional, per-speaker representations may be passed through a decoder to generate per-speaker waveforms.

A microphone may be in communication with the data processing hardware and may be configured to detect the speech mixture. A vehicle may incorporate the microphone.

In another configuration, a system for speech separation is provided and includes data processing hardware and memory hardware in communication with the data processing hardware, the memory hardware storing instructions that when executed on the data processing hardware cause the data processing hardware to perform operations including (i) generating a two-dimensional representation of a speech mixture, (ii) separating the speech mixture into an initial separation, (iii) supplying the initial separation and at least one feature projection to a refinement module, (iv) refining the initial separation based on the initial separation and the at least one feature projection, (v) estimating a mask per speaker, and (vi) applying the masks to the two-dimensional representation to create two-dimensional, per-speaker representations.

The system may include one or more of the following optional features. For example, generating a two-dimensional representation of the speech mixture may include passing the speech mixture through an encoder. Additionally or alternatively, speaker representations may be supplied to the refinement module for use by the refinement module in refining the initial separation.

A speaker embedding table may be used to refine the speaker representations. Additionally or alternatively, the two-dimensional, per-speaker representations may be passed through a decoder to generate per-speaker waveforms.

A microphone may be in communication with the data processing hardware and may be configured to detect the speech mixture. A vehicle may incorporate the microphone.

In yet another configuration, a system for speech separation is provided and includes data processing hardware and memory hardware in communication with the data processing hardware, the memory hardware storing instructions that when executed on the data processing hardware cause the data processing hardware to perform operations including (i) generating a two-dimensional representation of a speech mixture, (ii) separating the speech mixture into an initial separation, (iii) supplying the initial separation to a speaker module, (iv) generating per-frame representations of the initial separation that are consistent with stored speaker representations, (v) refining the initial separation based on the initial separation and the speaker representations, (vi) estimating a mask per speaker, and (vii) applying the masks to the two-dimensional representation to create two-dimensional, per-speaker representations.

The system may include one or more of the following optional features. For example, generating a two-dimensional representation of the speech mixture may include passing the speech mixture through an encoder. Additionally or alternatively, a speaker embedding table may be used to refine the speaker representations.

In one configuration, the two-dimensional, per-speaker representations may be passed through a decoder to generate per-speaker waveforms.

A microphone may be in communication with the data processing hardware and may be configured to detect the speech mixture. A vehicle may incorporate the microphone.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle in accordance with the principles of the present disclosure;

FIG. 2 is a schematic representation of a body control module for use with the vehicle of FIG. 1; and

FIG. 3 is a flowchart detailing a system and method for speech separation in accordance with the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

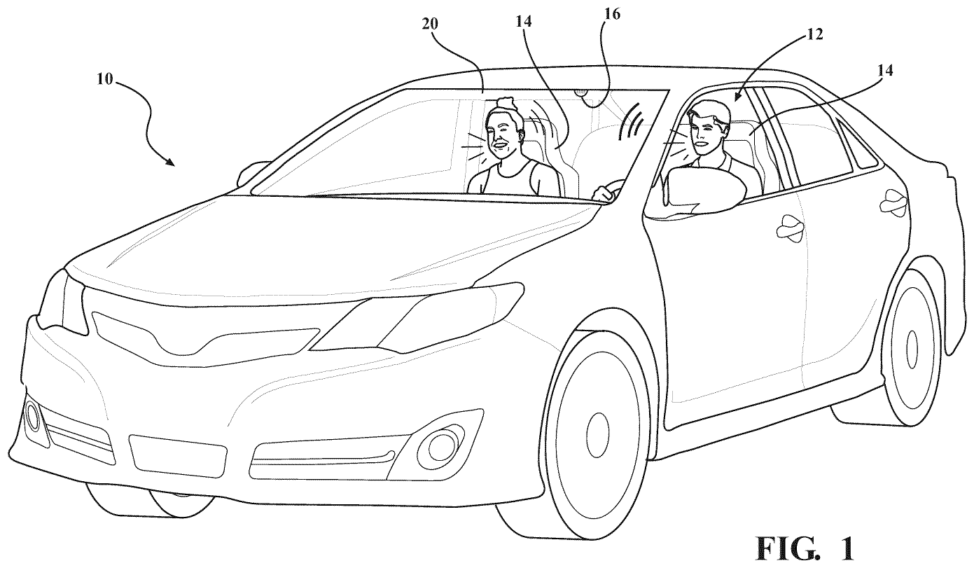

With particular reference to FIG. 1, a vehicle 10 is provided. The vehicle 10 includes a cabin 12, one or more seats 14 disposed within the cabin 12, and a microphone 16. As shown in FIG. 1, the microphone 16 is positioned within the cabin 12 proximate to one or both of the seats 14. For example, the microphone 16 may be located between a pair of front seats 14 such that the microphone 16 is substantially equidistant from each seat 14. In one configuration, the microphone 16 is located in a headliner 20 of the vehicle 10 to place the microphone 16 in close proximity to occupants of the vehicle 10 when seated on the seats 14. While the vehicle 10 is described and shown as including a single microphone 16, the vehicle 10 could include multiple microphones 16 located at various locations within the cabin 12.

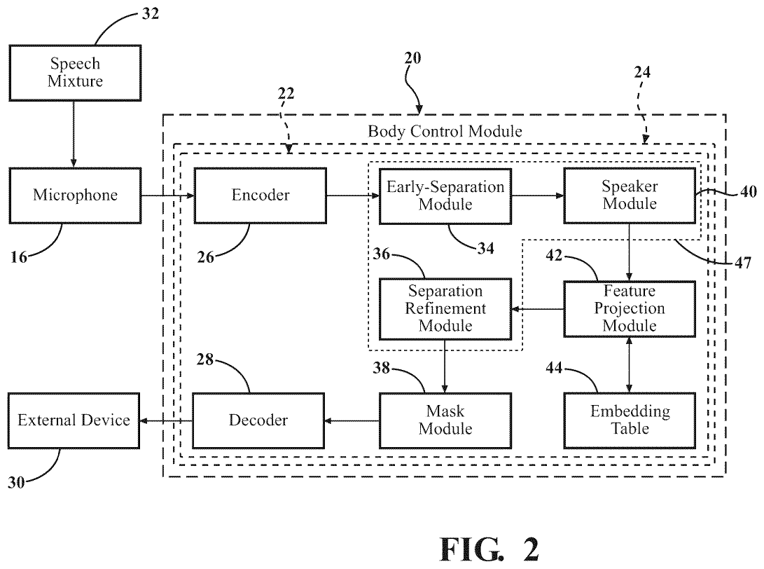

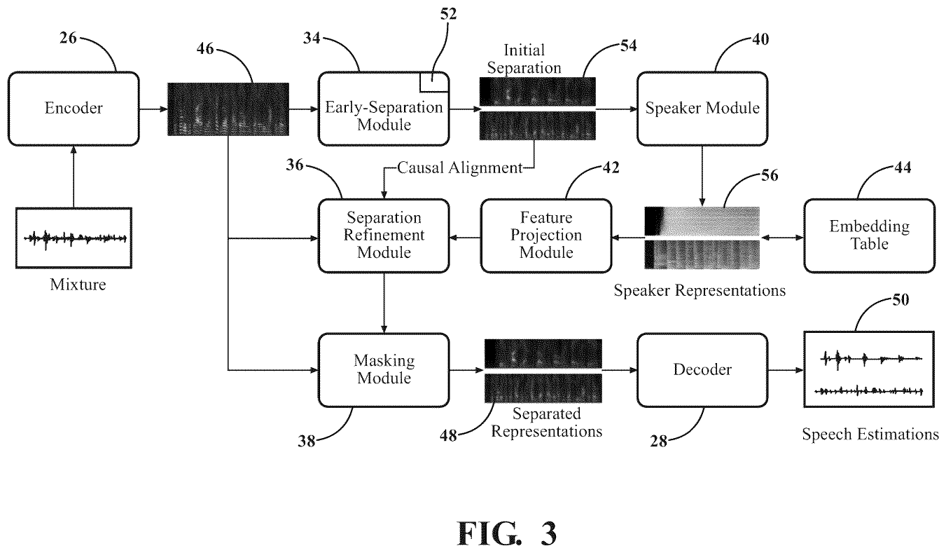

With particular reference to FIG. 2, a body control module (BCM) 20 of the vehicle 10 is schematically represented. The BCM 20 includes data processing hardware 22 and memory hardware 24 that cooperate to execute the speech separation system and method shown in FIG. 3. The data processing hardware 22 and memory hardware 24 include an encoder 26 in communication with the microphone 16 and a decoder 28 in communication with an external device 30 such as, for example, a mobile phone.

The encoder 26 may utilize a Fast Fourier transform (FFT) method to process a speech or waveform mixture signal 32 received by the microphone 16. The FFT may be a short-time Fast Fourier transform (STFT) and, further, may be used in conjunction with a learned Filterbank. For example, the encoder 26 may employ a learned Filterbank having a frame size of 16 samples and an overlap of eight (8) samples with a depth of 512 implemented with a one-dimensional convolution layer, followed by a rectified linear unit (ReLU) activation function. The encoder 26 may use the FFT to convert the speech mixture signal 32 from its original time domain into a two-dimensional representation of the speech mixture signal 32. For example, the encoder 26 may transform the original time domain of the speech mixture signal 32 into the frequency domain to produce a two-dimensional representation of the signal 32.

The decoder 28 may similarly utilize a FFT method to convert the two-dimensional representation of the speech mixture signal 32 into a waveform signal (i.e., return the speech mixture signal 32 to the time domain from the frequency domain) before the signal is transferred to the external device 30. The decoder 28 may employ an inverse short-time FFT (iSTFT) and, further, may be used in conjunction with a learned Filterbank. For example, the encoder 26 may employ a learned Filterbank having a frame size of 16 samples and an overlap of eight (8) samples with a depth of 512 implemented with a one-dimensional convolution layer, followed by a rectified linear unit (ReLU) activation function. It should be noted that the decoder 28 does not convert the same speech mixture signal 32 received by the encoder 26 to the time domain but, rather, converts a two-dimensional representation of a separated speech signal, which is determined based on the flowchart shown in FIG. 3, as will be described in greater detail below:

With continued reference to FIG. 2, the memory hardware 24 stores and the data processing hardware 22 executes an early-separation(ES) module 34, a separation-refinement (SR) module 36, a mask module 38, a speaker module 40, a feature-projection (FP) module 42, and an embedding table 44. As will be described in greater detail below; the ES module 34, the SR module 36, and the speaker module 40 cooperate to separate the two-dimensional representation of the speech mixture 32 received from the encoder 26 into individual speakers, which is then sent to the decoder 28 for use by the decoder 28 in generating per-speaker waveforms. As such, the ES module 34, the SR module 36, and the speaker module 40 collectively form a speech separator 47.

With particular reference to FIG. 3, a flowchart detailing operation of the speech module 40) and associated encoder 26 and decoder 28 will be described in detail. The speech module 40) is a masking-based, encoder-decoder model. As will be described, the input speech or waveform mixture 32, as detected by the microphone 16, is processed by the encoder 26, which generates a two-dimensional representation 46 of the mixture 32. The two-dimensional representation 46 is then passed to the masking module 38 that estimates a mask per speaker. The masks are applied to the two-dimensional signal representation 46 to create two-dimensional, per-speaker representation estimations 48 of the two-dimensional signal representation 46. The estimations 48 are then passed through the decoder 28 to achieve per-speaker waveforms 50.

In operation, the input speech mixture 32 may be detected by the microphone 16 when one or more occupants are seated in the cabin 12. For example, the microphone 16 may detect speech from occupants seated on respective front seats 14 of the cabin 12. The detected speech will include a mixture of the two, seated occupants as well as additional interfering noise. The input speech mixture 32 is transmitted to the encoder 26, which converts the speech mixture signal 32 from its original time domain into a two-dimensional representation 46 of the speech mixture signal 32, as described above.

The two-dimensional representation 46 is transmitted to the ES module 34, which generates estimates of speaker masks. The estimated speaker masks 52 are applied to the two-dimensional representation 46 to achieve encoded speaker estimates or an initial separation 54 of the two-dimensional representation 46. The encoded speaker estimates 54 are then provided to the SR module 36.

The ES module 34 is initially trained as a standalone separator within an encoder-decoder model. The ES module 34 may be trained using utterance-level permutation invariant training (uPIT) with the same reconstruction loss. For example, the ES module 34 may be trained as a separator using uPIT with negative Scale-invariant signal-to-distortion ratio (SI-SDR) used as a loss term. The same encoder 26 and decoder 28 may also be used for the system shown in FIG. 3 where the speech separator 47 is used as an early-separation module. When training the full system shown in FIG. 3, the ES module 34 and the encoder 26 are frozen while the training of the decoder 28 is continued. The full system shown in FIG. 3 may then be trained using the negative SI-SDR as a loss. It should be noted that while the ES module 34 and the encoder 26 are described as being frozen following training, the ES module 34 could continue training along with the full system shown in FIG. 3 in an effort to continuously improve the ability of the ES module 34 to separate the two-dimensional representation 46.

A temporal convolutional network (TCN) may be used to implement the ES module 34. The TCN may have 512 convolutional block channels, a skip connection path, as well as a residual (bottleneck). With 128 channels each, each dilated convolution has a kernel size of three (3). The ES module 34 is composed of three (3) repeats with eight (8) convolutional blocks per repeat. In one configuration, all of the convolutions are implemented as causal, thereby creating a fully causal model. Alternatively, bottom convolutional blocks of the ES model 34 may be non-causal to allow for a small look-ahead filter.

The encoded speaker estimates 54 are sent to the speaker module 40. The speaker module 40 receives the speaker estimates or initial separation 54 and generates per-frame representations 56 that are consistent with a stored representation of the speaker. These per-frame representations may be used to separate the speakers in the two-dimensional representation 46. The consistency to the speaker representation is trained using the embedding table 44, as will be described in greater detail below.

The average value of one hundred (100) frames with 50% overlap of speaker representation are compared to speaker embedding table values contained in the embedding table 44. When the speaker representations 56 deviate from table values contained in the embedding table 44 for the speakers, the loss term is increased. In other words, the more the speaker representations 56 deviate from the values contained in the embedding table 44 for a particular speaker, the higher the loss term.

For example, a classification loss is used to measure the speaker deviation, whereby the loss increases when the representation estimate for a particular speaker (A) is distant from the stored representation for the speaker (A) in the embedding table 44. The loss may also be increased if the representation estimate of the speaker (A) is close to any other stored representation in the embedding table 44 (i.e., if the representation estimate for speaker (A) is close to the stored representation for speaker (B)). The losses may be used to train the speaker module 40 to cause the representation estimate for each speaker to move closer to their table value and further away from the table value of any other speaker. This way, the speaker module 40 is trained to bring the speaker representations 56 closer to those contained in the embedding table 44, thereby causing the speaker module 40 to generate more accurate speaker representations 56 in the future.

A causal TCN may be used in the embedding table 44, with ten (10) convolutional blocks and without repetition. The causal TCN may have a kernel of three (3), 512 channels, and 128 bottleneck channels. The first layer of the speaker module 40 may receive all initially separated signals together, such that for each frame, the module 40 receives a full filter bank representation size vector multiplied by the number of speakers. As an example, for two (2) speakers, and a representation size of 512, the speaker module 40 will receive 1024 size vectors per frame. The speaker module 40 will output a vector of the number of estimated speakers by the speaker representation size. In one configuration, the speaker representation size is 512 and, thus, for two (2) speakers the module 40 will output two (2) 512 size vectors per frame, concatenated to one vector of length 1024.

With continued reference to FIG. 3, the embedding table 44 receives the speaker representations 56 and aids in training the speaker module 40. The embedding table 44 is determined by the number of speakers in the dataset and the size of the speaker representation. For example, for a dataset of one hundred (100) speakers with a speaker representation (embedding) size of 512, the table 44 would have the following dimensions: 100×512. The embedding table 44 is used only in the training stage and is adjusted so that each speaker representation is pulled towards the representation generated by the speaker module 40 for better separation refinement results. While the embedding table 44 is described as being used only in the training stage, the embedding table 44 could be utilized in an on-going manner to continually improve the ability of the speaker module 40 in determining the speaker representations 56.

The speaker representations 56 generated by the speaker module 40 are transmitted to the feature projection module 42. Concatenated speaker representations are projected to the SR module 36 at a bottleneck layer of the SR module 36 as elementwise addition and multiplication features by putting the features through fully connected (FC) layers from the concatenated speaker representation vector to a vector the size of the bottleneck layer of the SR module 36. In one configuration, for 24 bottleneck representations in the SR module 36, 48 FC layers could be used that receive an input of size 1024 and output a vector of length 128. For each bottleneck representation, one of the vectors is used to elementwise multiply the representation while the other is added to the result.

As shown, the SR module 36 receives three (3) sets of signals. Namely, the SR module 36 receives the original two-dimensional representation 46 of the speech mixture 32, the initial separation 54 as provided by the ES module 34, and the speaker representations 56 via feature projection 42. The first layer of the SR module 36 receives all initially separated signals concatenated. Namely, for each frame, the SR module 36 receives a full filter bank representation size vector multiplied by the number of speakers. The SR module 36 receives the encoded mixture representation 54 as well. In the case where the system and method is fully causal, the initially separated signals are concatenated to the encoded mixture representation 54 and are provided to the SR module 36 together. If a look-ahead buffer is implemented, causal alignment may also be used.

The SR module 36 provides a mask for each speaker estimated. The masks provided by the SR module 36 are applied to the original encoded mixture 54 and are decoded back to the waveform domain into separate channels by the decoder 28. The SR module 36 may incorporate a TCN having the same dimensional properties as the ES module 34, aside from the handling of the additional inputs specified above and when utilizing causal alignment.

While the speaker module 40 is temporally aligned with the initially separated signals 54, when employing look-ahead (i.e., the mixture representation 54), the initially separated signals 54 are not aligned. Causal alignment may be used in such a situation to align the initially separated signals 54.

Look-ahead in an otherwise causal model may be achieved by converting several layers to non-causal. In a look-ahead implementation, the same selection of non-causal layers is used in both separators for processing the mixture representation 54. The early separated signals are processed using causal layers only, in parallel to the processing of the original mixture 46 by look-ahead layers. When the non-causal part of the SR module 36 is complete, the representation is summed with the representation from the early separated signals 54.

In one configuration, the SR module 36 begins by processing the early separation signals 54 using separate convolutional blocks for the same amount of non-causal layers that are used for the mixture processing. When the SR module 36 non-causal blocks are passed, the products of both the mixture and early separated signals are summed, and temporal alignment between the processing of the mixture and early separation is achieved.

As described, the system and method of FIG. 3 utilizes the initial separation results provided by the ES module 34 of a speech mixture 32, speaker representations 56 along with feature projections 42, and the initial speech mixture 32 to separate the initial speech mixture 32. The SR module 36 utilizes the foregoing information to generate masks at a masking module 38. The generated masks are applied to the original two-dimensional representation 46 of the speech mixture 32 to create separated representations 48. The separated representations 48 are sent to a decoder 28 to be transformed into individual speaker waveforms or speech estimations 50. The foregoing process provides for improved speech separation performance and low-latency.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for speech separation comprising:
data processing hardware;
memory hardware in communication with the data processing hardware, the memory hardware storing instructions that when executed on the data processing hardware cause the data processing hardware to perform operations comprising:
generating a two-dimensional representation of a speech mixture;
separating the speech mixture into an initial separation;
supplying the initial separation and speaker representations to a refinement module;
refining the initial separation based on the initial separation and the speaker representations;
estimating a mask per speaker; and
applying the masks to the two-dimensional representation to create two-dimensional, per-speaker representations.

2. The system of claim 1, wherein generating a two-dimensional representation of the speech mixture includes passing the speech mixture through an encoder.

3. The system of claim 1, further comprising supplying at least one feature projection to the refinement module for use by the refinement module in refining the initial separation.

4. The system of claim 1, further comprising using a speaker embedding table to refine the speaker representations.

5. The system of claim 1, further comprising passing the two-dimensional, per-speaker representations through a decoder to generate per-speaker waveforms.

6. The system of claim 1, further comprising a microphone in communication with the data processing hardware and configured to detect the speech mixture.

7. A vehicle incorporating the microphone of claim 6.

8. A system for speech separation comprising:
data processing hardware;
memory hardware in communication with the data processing hardware, the memory hardware storing instructions that when executed on the data processing hardware cause the data processing hardware to perform operations comprising:
generating a two-dimensional representation of a speech mixture;
separating the speech mixture into an initial separation;
supplying the initial separation and at least one feature projection to a refinement module;
refining the initial separation based on the initial separation and the at least one feature projection;
estimating a mask per speaker; and
applying the masks to the two-dimensional representation to create two-dimensional, per-speaker representations.

9. The system of claim 8, wherein generating a two-dimensional representation of the speech mixture includes passing the speech mixture through an encoder.

10. The system of claim 8, further comprising supplying speaker representations to the refinement module for use by the refinement module in refining the initial separation.

11. The system of claim 10, further comprising using a speaker embedding table to refine the speaker representations.

12. The system of claim 8, further comprising passing the two-dimensional, per-speaker representations through a decoder to generate per-speaker waveforms.

13. The system of claim 8, further comprising a microphone in communication with the data processing hardware and configured to detect the speech mixture.

14. A vehicle incorporating the microphone of claim 13.

15. A system for speech separation comprising:
data processing hardware;
memory hardware in communication with the data processing hardware, the memory hardware storing instructions that when executed on the data processing hardware cause the data processing hardware to perform operations comprising:
generating a two-dimensional representation of a speech mixture detected by at least one microphone located within or remote from a vehicle cabin;
separating the speech mixture into an initial separation;
supplying the initial separation to a speaker module;
generating per-frame representations of the initial separation that are consistent with stored speaker representations;
refining the initial separation based on the initial separation and the speaker representations;
estimating a mask per speaker based on the refinement of the initial separation; and
applying the masks to the two-dimensional representation to create two-dimensional, per-speaker representations.

16. The system of claim 15, wherein generating a two-dimensional representation of the speech mixture includes passing the speech mixture through an encoder.

17. The system of claim 15, further comprising using a speaker embedding table to refine the speaker representations.

18. The system of claim 15, further comprising passing the two-dimensional, per-speaker representations through a decoder to generate per-speaker waveforms.

19. The system of claim 15, further comprising a microphone in communication with the data processing hardware and configured to detect the speech mixture.

20. A vehicle incorporating the microphone of claim 19.
